(19) United States
(12) Patent Application Publication
(10) Pub. No.: US 2008/0135396 A1
(43) Pub. Date: Jun. 12, 2008

(54) Separation Method

(75) Inventor: Stephan Rudiger Blum, Calgary (CA)

Correspondence Address: COHEN, PONTANI, LIEBERMAN & PAVANE, 551 FIFTH AVENUE, SUITE 1210, NEW YORK, NY, 10176, US

(73) Assignee: WHITE FOX TECHNOLOGIES LIMITED, South Kensington, London (GB)

(21) Appl. No.: 11/918,919

(22) PCT Filed: Apr. 19, 2006
(86) PCT No.: PCT/DE2006/000680

§ 371 Date: Dec. 21, 2007

(30) Foreign Application Priority Data
Apr. 12, 2005 (DE) 10 2005 018 508.8

(51) Int. Cl. B01D 3/32; B01D 3/14

(52) U.S. Cl. 203/25; 203/21; 203/27

(57) ABSTRACT

A feed stream is fed to a first distillation stage comprising at least one distillation column (stripper) and the distillate from the first distillation stage is fed to a second distillation column (rectifier). The feed stream is sub-divided into two streams and fed to two distillation columns, in such a way that the rectifier maintains a predefined energy balance.

The invention pertains to a separation process, especially to the distillation of ethanol as an end product from a mash.

In a conventional process for the distillation and dehydration of ethanol from a beer mash containing approximately 10% ethanol, 85% water, and 5% solids after fermentation, the mash is preheated and sent to a first distillation column. In the first distillation column, the mash is condensed by evaporation, as a result of which solid components can be discharged as a bottom product along with water. Some of this bottom product is usually reheated and returned to the distillation column (reboiler).

The first distillate is in the form of vapor and still contains water, ethanol, and fusel oils. It is sent, possibly by way of a collecting and mixing tank, to a second distillation column, which is designed as a rectification column. Further separation occurs in this rectification column, during which the fusel oils are discharged in a sidestream. A small portion of the water precipitated out in the second distillation column as a bottom product is reheated and returned to the rectification column (reboiler) and also discharged, so that it is removed from the production process. Some of the distillate of the second distillation column, still containing water and ethanol, can be returned to the first and second distillation columns, possibly by way of the previously mentioned collecting tank. [symbol] be returned to the first and second distillation columns, possibly by way of the previously mentioned collecting tank.

The predominant amount of the ethanol-water mixture constituting the second distillate, consisting of approximately 95% ethanol and 5% water, is subjected to a final dehydration to obtain the purest possible ethanol with a purity of 99-99.8%. This last dehydration step is carried out by means of molecular sieves, in which crystalline zeolites, acting like sponges, adsorb the H₂O molecules.

The zeolites of a molecular sieve, however, rapidly become saturated with water. So that uniform dehydration results can be obtained, therefore, the water-saturated zeolites must be regenerated. Molecular sieves are therefore normally used in pairs. Thus highly pure ethanol can be obtained from a first, active molecular sieve, and this ethanol can also be used to regenerate a second, passive molecular sieve. When a passive molecular sieve is regenerated, the ethanol being used can be returned to a distillation column. This return stream can amount to approximately 30% of the pure ethanol obtained from the active molecular sieve. The constant pressure swings to which the molecular sieves are subjected lead to the formation of dust through the abrasion of the filler material. This material collects in downstream stages of the installation, which makes it necessary to replace these stages completely at certain intervals. This has a disadvantageous effect on investment and operating costs.

The dehydration of ethanol is an energy-intensive process. In particular, the condensation of the mash in the first distillation column as well as the need for large return flows of distillate lead to considerable operating and investment costs. Before the ethanol-water mixture can be treated with molecular sieves, furthermore, the ethanol concentration must be significantly increased to approximately 90-95%. For this purpose, the substance mixture must be rectified as close as possible to the azeotropic point, which requires a great deal of apparatus and leads to considerable operating costs. The rectification column must therefore have a large number of separation stages and a high return flow rate.

It is known from PCT/DE2004/000867 that the energy requirement of the rectification column can be decreased by replacing the molecular sieves with membrane filtration units. As a result of this measure, the distillate of the rectification column needs to have a concentration of only 80 wt. % ethanol. The required return flow is therefore much smaller than that necessary for a process based on molecular sieves. The energy requirement of the first distillation column, i.e., the stripper, remains unchanged. Nevertheless, the overall energy balance is still not satisfactory, because the rectification column is operating on a lower energy level and therefore the amount of excess energy which can be sent back from the rectification column to the first distillation column is correspondingly smaller. The first column must therefore be supplied with a considerable amount of outside energy.

Against this technical background, the task of the invention is to provide a separation process by means of which the economics of the process can be improved, especially the economics of the dehydration of ethanol from a mash.

To solve this technical problem, it is proposed for a separation process, especially for the distillation of ethanol from a mash, in which a feed is sent to a first distillation stage with a distillation column, i.e., a stripper, and the distillate of the first distillation stage is sent to a second distillation column, i.e., a rectification column, that, according to Claim 1, the feed be split into two streams and sent to two distillation columns in such a way that the rectification column maintains a defined energy balance.

The separation process according to the invention offers a series of advantages. Previously, the energy concept of a distillation plant was determined by the design of the stripper. According to the invention, however, the first distillation stage is operated on the basis of the energy input from the rectification column, which can thus be operated under optimal conditions. The energy balance of the rectification column thus essentially determines that of the first distillation stage.

In a first variant of the process, the feed can simply be split into two streams, so that both streams have similar energy and/or chemical potentials. These streams are then each sent to a distillation column. In most cases, the volume flow rate of the two streams will also be approximately on the same order of magnitude, each accounting for approximately half of the total, but, as a function of the configuration of the first and second distillation stages, it can also be effective in individual cases to split the volume flow rates differently.

When the feed is split simply in this way, different volume flow rates can occur when a first stream is sent to a stripper and a second stream is sent to a rectification column. If provisions are then also made to return a bottom product of the rectification column, namely, the distillation column in the downstream position with respect to the course of the process, to a stripper as the upstream column, the energy balance per liter of end product already becomes about 40% superior to that of conventional processes.

Alternatively, if the feed is divided similarly into two streams and if two strippers are provided in the first distillation stage, one stream can be sent to each stripper, where preferably the volume flow rates of the two streams will be approximately the same. If then, in a preferred embodiment, it is also provided that a bottom product of a first stripper, preferably operating at high pressure, is sent to a second stripper, preferably operating at a lower pressure, and if, in addition, the distillate of the rectification column is purified in a membrane filtration device, the energy balance improves by more than 60%.

In a further embodiment of the process of the invention, separation devices such as screens, filters, membranes, centrifuges, etc., can be used to obtain a higher concentration in one of the feeds. When the feed is separated in this way into two liquid phases of essentially the same energy level, it is possible in a preferred variant of the process according to the invention to send the retentate of, for example, a membrane separation device in one stream to a stripper and to send the permeate in another stream to a rectification column.

When a separation device is used, the feed is usually also separated into a low-solids or even solids-free stream and a high-solids stream.

If the feed is separated into two streams, one of which is in the liquid phase and the other has an elevated temperature and/or in particular is in the vapor phase, then this stream with the elevated temperature, especially the retentate of, for example, a membrane separation device, can be sent to a stripper, preferably to the top of the stripper, and will be ready there to enter the rectification column together with the distillate of this stripper. The stream of lower temperature, e.g., the permeate, is fed into a lower part of the stripper column.

In an elaboration of the previously described process, a vapor phase-generating separation device such as an evaporator can be provided, especially a device which generates a vapor phase by expansion, or a distillation column can be used, the distillate of which enters the rectification column along with the distillate of a stripper, whereas its bottom product is sent to the stripper in addition to another stream branched off from the feed.

Normally, the power requirement for the operation of the first distillation stage will be completely covered by the excess energy obtained from the operation of the rectification column and from the recovery of heat from the end product. Thus optimal use is made of the separation process according to the invention, because the operation of the first distillation stage is determined completely by the rectification column and the heat recovery from the end product.

The distillation columns are preferably run at different operating pressures, in particular at pressures which allow optimal heat recovery. This guarantees the lowest possible heat loss.

This also makes it possible to operate three distillation columns in a cascade configuration. Under the assumption that the rectification column is operated at the highest energy level, a stripper can be run on an intermediate energy level with the excess energy obtained from the rectification column. With the excess energy from the stripper column, preferably a second stripper can then be run on a low energy level.

So that the energy level of the stripper operating on the intermediate level can be kept as high as possible, it is preferable for the heat recovered from the end product to be fed into the reboiler circuit of the distillation column operated on the intermediate energy level.

The amount of heat recovered from the end product can be considerably increased if the concentration of the end product in the feed is at least 20%. The energy input into the entire system can then be considerably reduced in relation to the quantity of end product obtained. Increasing the ethanol fraction in the feed by about 10%, for example, can be achieved by means of an appropriate fermentation technique. Alternatively, an upstream process such as membrane separation, as previously mentioned, could be used to increase the amount of end product in the feed. As a result of these measures, the fraction of the end product in the overall system increases considerably. These measures lead to a further significant increase in the yield of end product and thus also to an increase in the amount of heat recovered, which can be fed back into the system.

In correspondence with conventional processes, the distillate of the rectification column can be purified by molecular sieves or preferably by membrane separation in a filtration device. In particular, it is also possible for a regenerate of such a filtration device located downstream from a rectification column to be sent back to a stripper again.

The separation process according to the invention is explained in greater detail on the basis of the drawing, which illustrates the various sequences of process steps in schematic fashion:

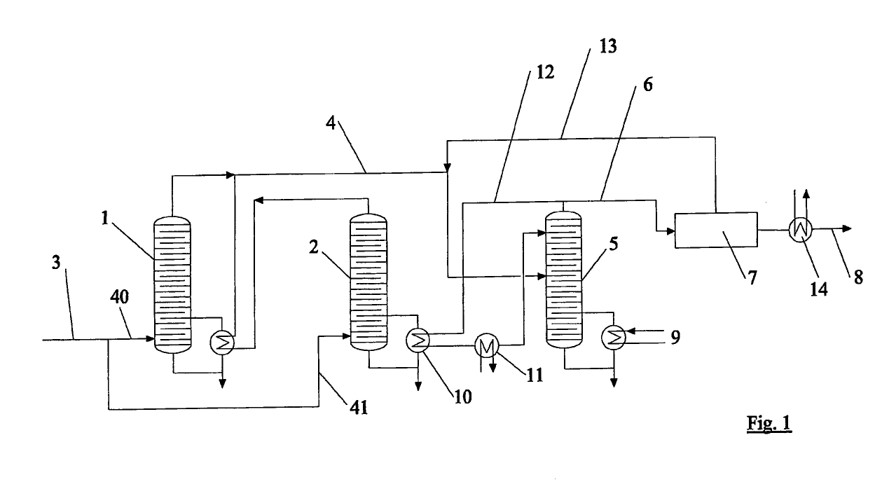

FIG. 1 shows three distillation columns and a final purification stage using molecular sieves;

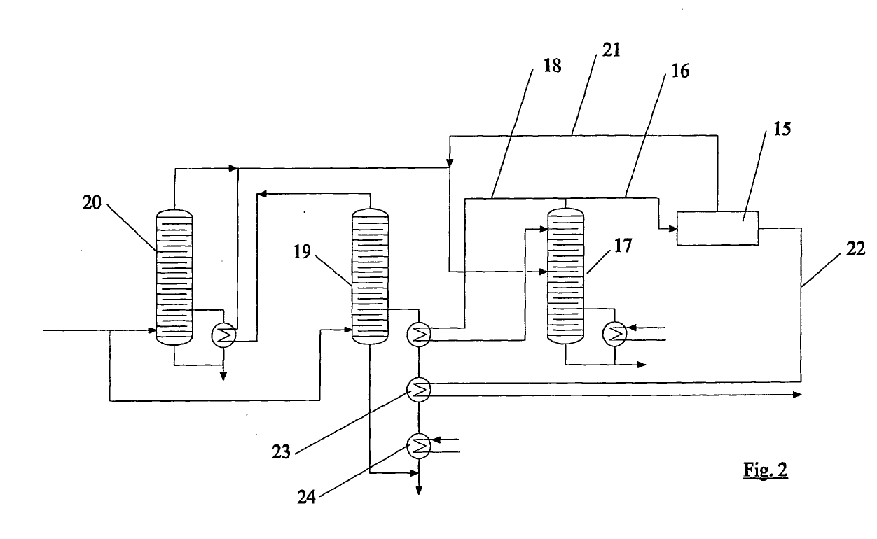

FIG. 2 shows an arrangement of three distillation columns and a final purification stage consisting of a membrane separation process;

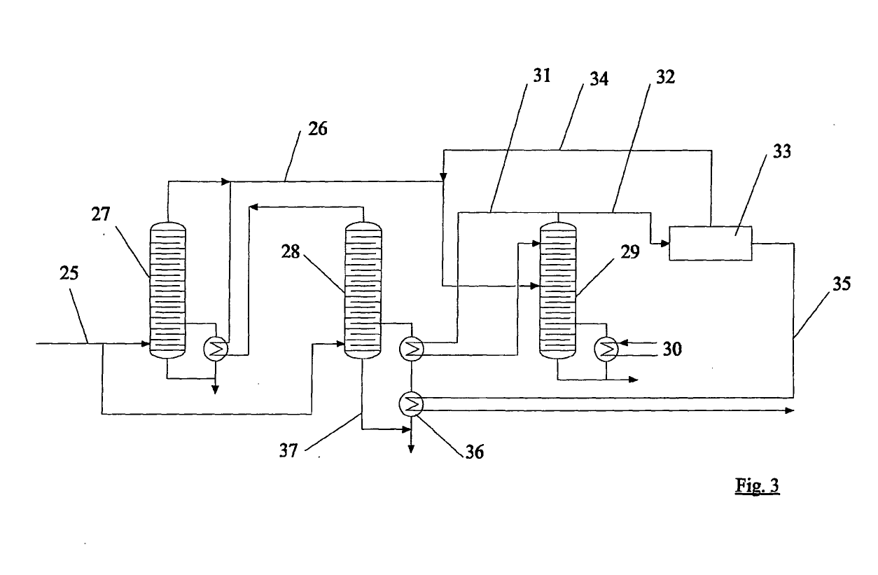

FIG. 3 shows another arrangement of three distillation columns;

FIG. 4 shows variants of how a regenerate can be fed to a filtration device of a final purification stage;

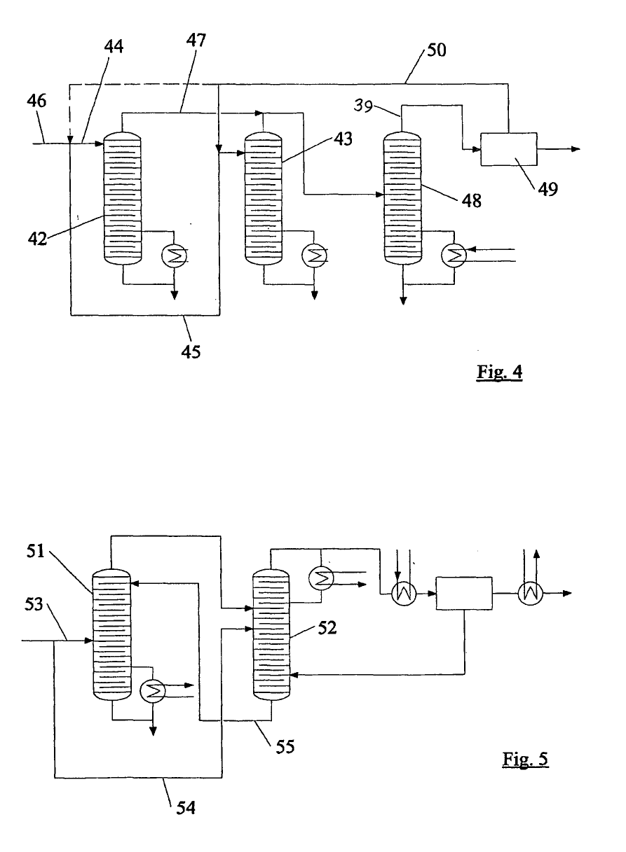

FIG. 5 shows an arrangement of two distillation columns;

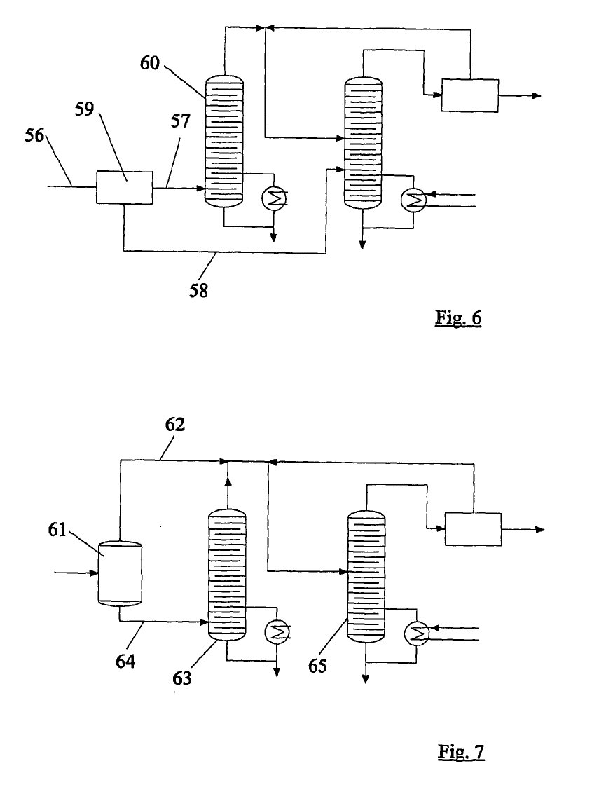

FIG. 6 shows a variant of how the feed can be split in the case of two distillation columns;

FIG. 7 shows a splitting of the feed into preferably a liquid and a vapor phase;

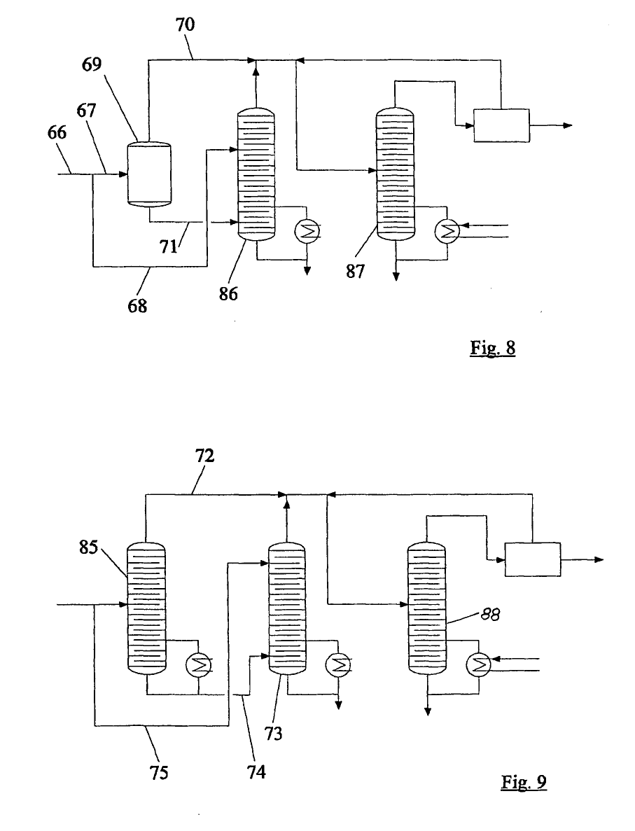

FIG. 8 shows a variant of the splitting into a liquid and vapor phase;

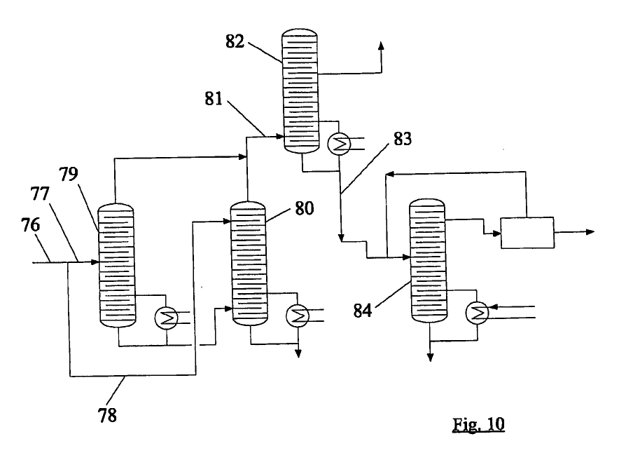

FIG. 9 shows a splitting into a liquid and a vapor phase by means of a distillation column; and

FIG. 10 shows a variant thereof.

In FIG. 1, two parallel-connected strippers 1, 2 form a first distillation stage for a separation process, such as for the distillation of ethanol from a beer mash. The feed 3, containing approximately 11.5% ethanol, is split into two streams 40, 41 of similar chemical and energy potentials and supplied to the two strippers 1, 2 in equal amounts. The distillate 4 from the two strippers 1, 2 is sent jointly to a rectification column 5. The distillate 6 of that column is purified by molecular sieves 7 and discharged as, for example, high-purity methanol with a purity of 99.6% as product stream 8.

According to the invention, the rectification column 5 can be run at the highest energy level. For example, approximately 18,000 kW of primary energy 9 are supplied, indicated by the heat exchanger in the reboiler circuit of the rectification column 5. This includes an excess of approximately 9,800 kW, some of which, as indicated, is fed via a heat exchanger 10 in the return line 12 of the rectification column 5 to the stripper 2, so that this can be run on an intermediate energy level. Only approximately 8,500 kW are required, however, for the operation of the stripper 2, which means that approximately 1,300 kW can be taken unused from the circuit, as indicated by the heat exchanger 11 in the return line 12.

The stripper 1 is operated with the excess energy from the stripper 2. Approximately 6,500 kW are required for the first stripper, which means that, if there is an excess of approximately 6,900 kW from the stripper 2, it is again possible to discharge excess energy in the amount of approximately 400 kW.

Some of the excess energy can be used for the regeneration and operation of the molecular sieves 7. There is still an energy content of approximately 8,200 kW, however, in the distillate 6, which is being sent with an ethanol purity of 93%, for example, to the molecular sieves 7. It is true that some of this energy, i.e., approximately 3,000 kW, for example, is used for the operation of the rectification column 5 by supplying the regenerate 13 of the molecular sieves 7 or the like to the column, but approximately 5,200 kW ultimately still remains in the product stream 8. Because of the way in which the molecular sieves 7 are operated, most of this energy, e.g., about 5,000 kW, can be removed cyclically from the system as unused heat, as indicated by the heat exchanger 14.

If the distillate is ethanol, a production rate of 19.57 L/h can be achieved in this example at 1.58 kg of steam/L of ethanol.

To ensure the cascade-like transfer of energy from one distillation column to the next, the distillation columns 1, 2, 5 are run at different, graduated pressures. As a result, it is possible for the distillation columns 1, 2, and 5 to operate in optimal fashion with optimal energy transfer.

In the process according to FIG. 2, the molecular sieves are replaced—a measure which has far-reaching consequences—by a membrane filtration device 15. To operate this device in the case of ethanol, the distillate 16 of the rectification column 17 needs to have a purity of only 80%, for example. As a result, the primary energy input needs to be only about 10,500 kW. The return 18 is correspondingly lower in energy, and it thus provides only about 1,860 kW for the operation of the stripper 19. In corresponding fashion, the distillate 16 has an energy content of approximately 8,600 kW. The two strippers 19, 20, however, are to be operated essentially in accordance with the specifications of the preceding exemplary embodiment.

The permeate 21 of the membrane filtration device 15 remaining in the process again makes available about 3,000 kW for the operation of the rectification column 17. Therefore, about 5,600 kW remain in the product stream 22, of which about 5,000 kW can still be used advantageously in a continuous manner, indicated by a heat exchanger 23, for the operation of the stripper 19. Under the assumed conditions, there remains a coverage gap of approximately 1,660 kW, which must be supplied externally, as indicated by the heat exchanger 24. Nevertheless, 1 liter of ethanol is produced with 1.07 kg of steam for a product stream 22 of approximately 19.6 L/h.

In the process explained on the basis of FIG. 3, 20% of the feed 25 consists of the end product, e.g., ethanol. As a result, the quantity of distillate 26 of the two strippers 27, 28 is considerably increased, whereas the energy demand is increased only slightly and the working pressures remain unchanged. So that the increased quantity of the distillate can be processed, the rectification column 29 is operated at unchanged pressure with a primary energy input 30 of approximately 14,500 kW, of which approximately 2,500 kW is available in the return 31 for the operation of the stripper 28.

The distillate 32 being supplied to a membrane filtration device 33 has an energy content of approximately 12,500 kW at an ethanol content of, for example, 80%. Feeding the permeate 34 back to the rectification column 29 supplies about 4,700 kW. Thus about 7,800 kW remain in the product stream 35, which, as indicated by the heat exchanger 36, can be fed back to the reboiler circuit 37 for the operation of the stripper 28; here, this stripper has an energy requirement of about 9,700 kW, leaving an excess of 8,300 kW for the operation of the stripper 27, which requires only about 8,050 kW. Sufficient energy is therefore made available to all the strippers 27, 28, 29, which are connected to each other in an energy cascade. In addition, the product stream 35 is considerably increased to 30.46 L/h. This is obtained at an energy input of 0.83 kg of steam per liter of ethanol produced.

Variants are explained further on the basis of FIGS. 4-10, which show simplified diagrams.

FIG. 4 shows two strippers 42, 43, which are supplied with two similar streams 44, 45 of a feed 46. The distillate 47 of the two strippers 42, 43 is sent to a rectification column 48, and the distillate 39 of that column is sent to a filtration device 49.

In this exemplary embodiment, the regenerate 50 from the filtration device 49, especially again a membrane filtration device, is not fed back into the rectification column 48 but rather into one of the strippers 42, 43, as indicated in broken line in the drawing.

If desired, both strippers 42, 43 can be supplied with the regenerate 50.

In the case of the exemplary embodiment according to FIG. 4, the streams 44, 45 are of the same chemical and energy potential, and each is introduced by way of example into an upper part of the columns of the strippers 42, 43, whereas the distillate 47 of the strippers 42, 43 is introduced more-or-less into the middle part of the rectification column 48.

In the exemplary embodiment according to FIG. 5 with only one stripper 51 and a rectification column 52, the two streams 53, 54 are fed into the stripper and the rectification column 52. In this case, the volume flow rates of the two streams 53, 54 can also be significantly different from each other.

The bottom product 55 of the rectification column 52 is not discharged from the process but rather fed back to the stripper 51.

FIG. 6 shows the splitting of a feed 56 into two streams 57, 58 by means of a separation device 59. The separation device 59, designed with screens, filters, membranes, centrifuges, or the like, ensures, first, a significant increase in the fraction of the end product, e.g., ethanol, in the stream 57 being supplied to a stripper 60.

This stream 57 will then usually have not only an elevated concentration of the end product but also a low solids content or perhaps even no solids content at all.

In addition to a separation into two streams 57, 58 with liquid phases and with essentially the same energy potentials, a separation can also be carried out according to FIG. 7 by means of a suitably designed separation device 61 into a first stream 62 with a temperature higher than that of a second stream 64. This first stream can be in particular in the vapor phase and is sent together with the distillate present at the top of a stripper 64 to the rectification column 65. The second stream 64 is introduced into a lower part of the stripper 63.

Suitably designed separating devices 61 can be evaporators, for example, and in particular they can also be strippers 85 as shown by way of example in FIG. 9.

FIG. 8 shows a variant in which a feed 66 is split into two similar streams 67, 68. Stream 68 is sent directly to a stripper 86.

The other stream 67 is split again by a separating device 69 into two additional streams 70, 71. Stream 70 in particular is in the vapor phase and is sent again together with the distillate present at the top of the stripper 86 to the rectification column 87. The stream 71 can also be returned to the stripper 86 and thus remain within the process.

In FIG. 9, a stripper 85 is provided as the separating device (compare FIG. 8). Whereas the distillate 72 of the stripper 85 is of elevated temperature and is in particular in the vapor phase and is sent together with the distillate present at the top of a stripper 73 to the rectification column 88, the bottom product 74 of the stripper 85 is fed into the stripper 73.

The stripper 73 is also supplied with an additional stream 75, which has been branched off from the feed.

In the case of a process according to FIG. 9, it is advisable for the distillation column 65 to be run at a pressure higher than that of the stripper 73.

FIG. 10 shows how two strippers 79, 80 can be supplied by a feed 76, which is split into two similar streams 77, 78. After being combined as illustrated by way of example, the distillate 81 of those columns is sent to another distillation column 82. The bottom product 83 of that column is then introduced into a rectification column 84.

1.-14. (canceled)

15. A process for separating an end product from a feed, the process comprising:
splitting a feed into two streams;
sending at least one of said streams to a first distillation stage comprising at least one stripper;
producing a distillate in the first distillation stage; and
sending the distillate from the first distillation stage to a second distillation stage comprising a rectification column,
wherein the streams are processed so that the rectification column maintains a defined energy balance.

16. The process of claim 15 wherein the two streams each have the same energy.

17. The process of claim 15 wherein the two streams each have the same chemical potential.

18. The process of claim 15 wherein the two streams have different solids contents.

19. The process of claim 18 wherein one of said streams has no solids.

20. The process of claim 15 wherein the two streams are at different temperatures.

21. The process of claim 20 wherein one of the streams is in the vapor phase.

22. The process of claim 15 wherein the two streams are sent to the stripper and the rectification column, respectively.

23. The process of claim 15 wherein the two streams are sent to respective first and second strippers in the first distillation stage.

24. The process of claim 15 wherein the rectification column produces a bottom product which is returned to the stripper.

25. The process of claim 15 further comprising:
producing a distillate in the rectification column;
sending the distillate from the rectification column to a filtration device;
producing a regenerate in the filtration device; and
feeding the regenerate back to the stripper.

26. The process of claim 23 further comprising:
producing a bottom product in the first stripper; and
sending the bottom product from the first stripper to the second stripper.

27. The process of claim 23 wherein the first stripper is run at a higher pressure than the second stripper.

28. The process of claim 23 wherein the first stripper, the second stripper, and the rectification column are operated at progressively higher energies.

29. The process of claim 23 further comprising:
recovering heat from the end product; and
feeding the recovered heat into a reboiler circuit of the second stripper.

30. The process of claim 15 further comprising:
recovering heat from the end product;
recovering excess energy obtained during operation of the rectification column; and
operating the first distillation stage exclusively with the recovered heat and the excess energy.
